(19) United States
(12) Patent Application Publication
(10) Pub. No.: US 2016/0006283 A1
(43) Pub. Date: Jan. 7, 2016

(54) PORTABLE CHARGING DEVICE

(71) Applicant: Dake Liu, Westport, CT (US)

(72) Inventor: Dake Liu, Westport, CT (US)

(21) Appl. No.: 14/323,602

(22) Filed: Jul. 3, 2014

(51) Int. Cl. H02J 7/00

(52) U.S. Cl. CPC H02J 7/0052; H02J 7/007; H02J 7/0026; H02J 7/0014

(57) ABSTRACT

The present utility model discloses a portable charging device that includes a charging module, a battery protection module, a built-in battery pack with multiple battery cells, a voltage regulating output module, a microcontroller module, and an LCD display. Said charging device powers its externally connected electronic devices and in turn charges the batteries of those devices. Said charging module uses an input interface that matches the output interface of a personal computer's AC/DC power adapter. Said charging module charges said built-in battery pack through said battery protection module. Said built-in battery pack are connected to said voltage regulating output module to power externally connected electronic devices. Said microcontroller module connects to said battery protection module and said voltage regulating output module to control the charging and discharging process of said portable charging device. Said portable charging device provides convenience to its user by reusing the user's existing computer AC/DC power adapter as the energy input. It packs multiple battery cells and connects them electronically in series to maximize the energy intake from the computer AC/DC power adapter, improve charging efficiency, and significantly shorten the charging time of said charging device.

### BACKGROUND OF THE INVENTION

1. Field of the Invention

The present invention relates generally to portable charging device and more specifically it relates to portable rechargeable external battery packs also known as power banks that are used to power and charge consumer electronics such as smartphones, tablets, cameras.

2. Description of the Prior Art

With increasing usage of mobile devices such as smartphones, tablets, and cameras, people often find the capacities of their devices' built-in batteries too small to accommodate everyday use. As a result, a growing number of consumers start carrying with them large-capacity external battery packs (a.k.a. power banks) that can power and charge their mobile devices when needed.

Current high-capacity battery packs on the market come in a variety of sizes and capacities that suit consumer needs, but they are slow at recharging themselves, e.g., taking 4-12 hours to charge 10,000 mAh. That's a very long time that many consumers don't have the luxury for, especially when they are traveling or moving from place to place in everyday life with their mobile devices low on power. Some battery packs use large AD/DC adapter either built in or in standalone to speed up the charging, but result in very bulky devices that are no longer suited for portable use.

### SUMMARY

In view of the foregoing disadvantages inherent in the known types of rechargeable battery packs now present in the prior art, the general purpose of the present invention, which will be described subsequently in greater detail, is to provide a new portable charging device that has the advantages of the battery packs mentioned heretofore and novel fast charging, efficiency, and convenience features that result in a new rechargeable battery pack system which is not anticipated, rendered obvious, suggested, or even implied by any of the prior art battery packs, either alone or in any combination thereof.

To attain this, the present invention comprises a charging module, a battery protection module, a built-in battery pack with multiple battery cells, a voltage regulating output module, a microcontroller module, and an LCD display, wherein said charging module uses an input interface that matches the output interface of a personal computer's AC/DC power adapter, said charging module charges said built-in battery pack through said battery protection module, said built-in battery pack is connected to said voltage regulating output module to power and charge externally connected electronic devices, said microcontroller module connects to said battery protection module and said voltage regulating output module to control the charging and discharging process of said portable charging device, and said built-in battery pack includes multiple battery cells electrically connected in series,

Wherein said built-in battery pack includes 4 battery cells electrically connected in series,

Wherein said charging module comprises the first voltage reduction circuit of said portable charging device to drop input voltage from the computer power adapter to 16.8V for feeding said battery protection module,

Wherein said charging module is also connected to said voltage regulating output module. When the computer power adapter and external electronic device(s) are both connected to said portable charging device, the computer power adapter provides direct charging to the external electronic device(s) through said charging module and voltage regulating output module,

Wherein said battery protection module includes protective and charge balancing circuits to prevent every battery cell in said battery pack from overcurrent, overvoltage, overload, overcharge, over-discharge, short circuit, or overheating,

Wherein said voltage regulating output module includes the second voltage reduction circuit of said portable charging device to drop voltage from said built-in battery pack with serially connected battery cells to 5V for charging externally connected electronic devices,

Wherein said voltage regulating output module also includes circuits to detect the connection of external devices and provide overcurrent protection during the process of charging those external devices,

Wherein said voltage regulating output module also includes interfaces that match the externally connected electronic devices,

Wherein said LCD display is connected to said microcontroller module for displaying battery status and charging and discharging information.

Compared to known types of rechargeable battery packs in the prior art, the new portable charging device provides better convenience by using commonplace computer AC/DC power adapter as the input and achieves faster recharging at comparable size, weight, and capacity by serially connecting multiple battery cells to take advantage of the computer power adapter's high power output. At 10,000 mAh capacity, for example, the new portable charging device can shorten required full recharge time by more than 2 hours.

### BRIEF DESCRIPTION OF THE DRAWINGS

FIG. 1 is the overall module diagram of an embodiment of the utility model.

FIG. 2 is the voltage reduction circuit diagram of the embodiments charging module.

FIG. 3 is the circuit diagram of the embodiment's battery protection module.

FIG. 4 is an illustrative diagram of the connection of the embodiment's battery cells.

FIG. 5 is a schematic diagram of the embodiment's microcontroller module.

FIG. 6 is a schematic diagram of the embodiment's LCD display connections to the microcontroller module.

FIG. 7 is an illustration of the display reading of the embodiment's LCD display.

FIG. 8 is the voltage reduction circuit diagram of the embodiment's voltage regulating output module.

FIGS. 9a and 9b are diagrams of the overcurrent protection and external device detection circuits of the embodiment's voltage regulating output module.

### DESCRIPTION OF THE PREFERRED EMBODIMENT

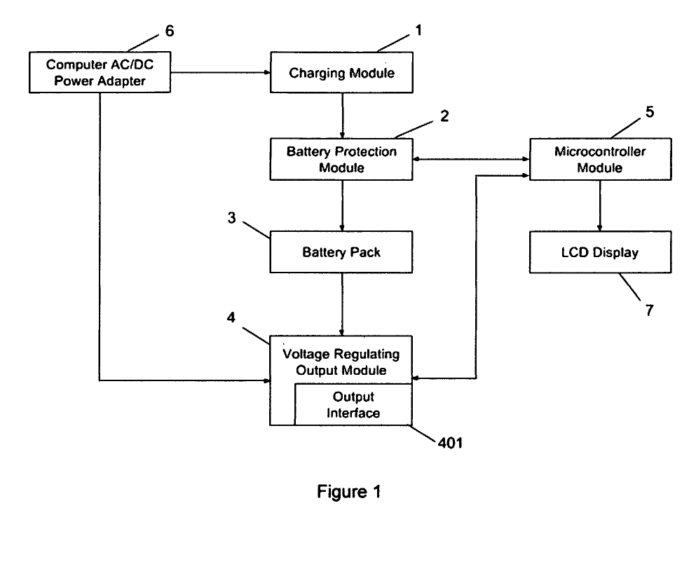

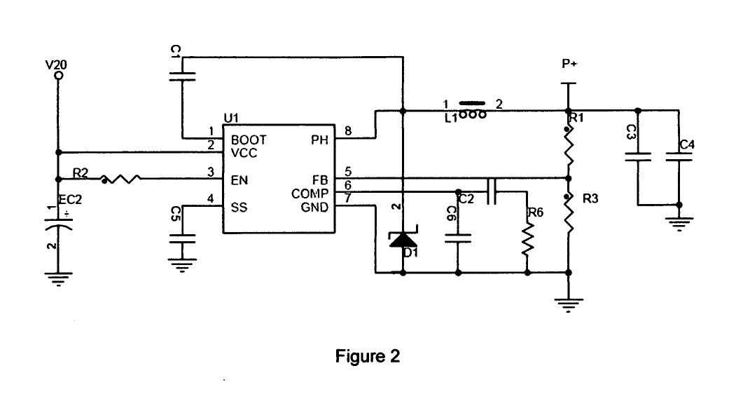

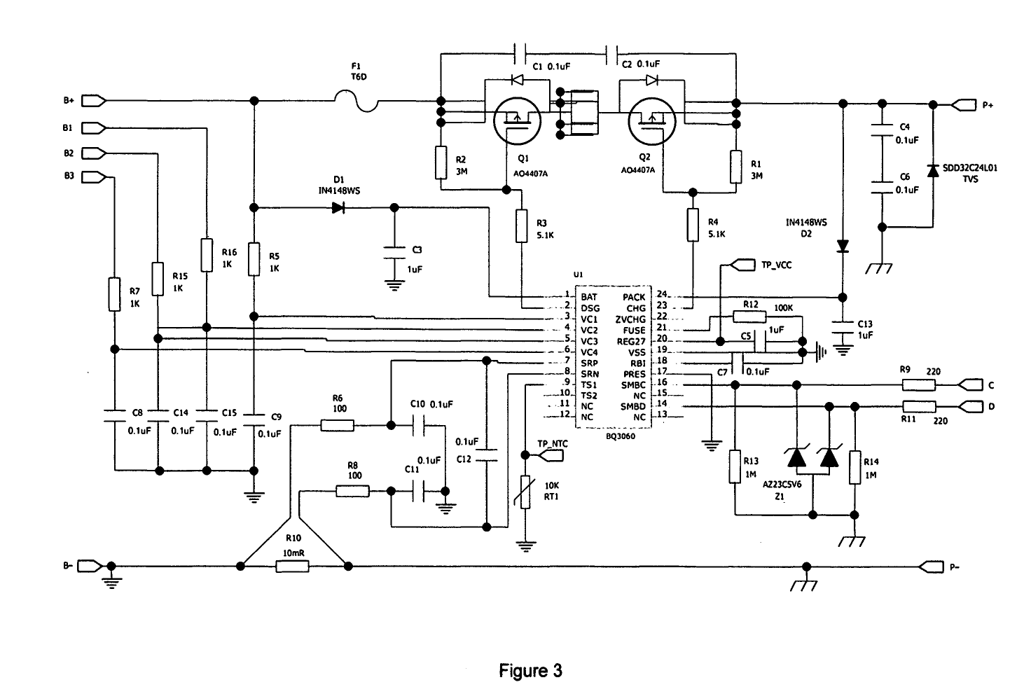

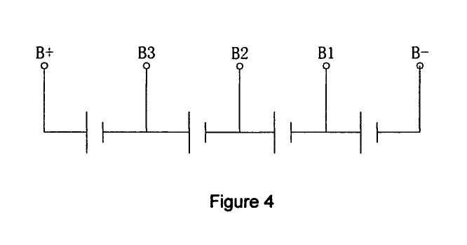

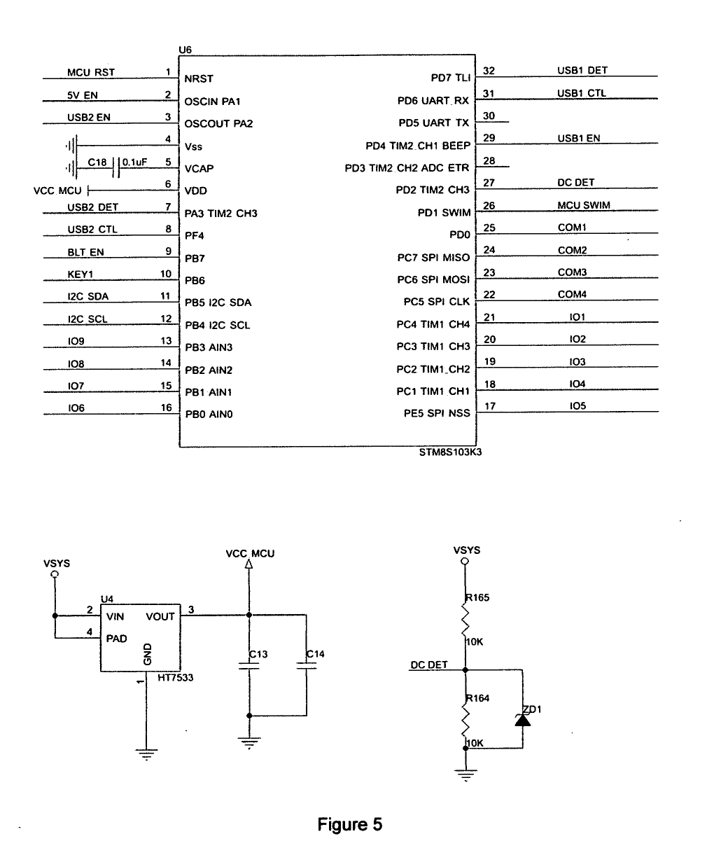

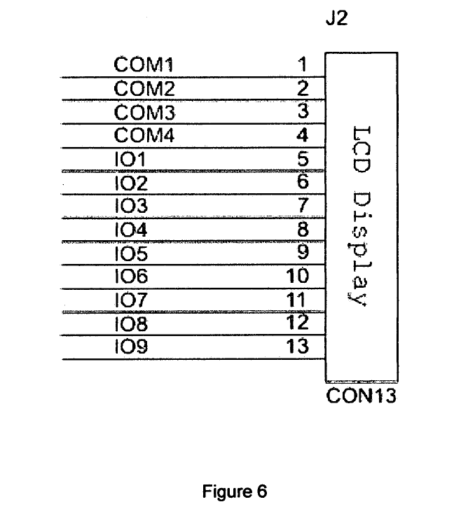

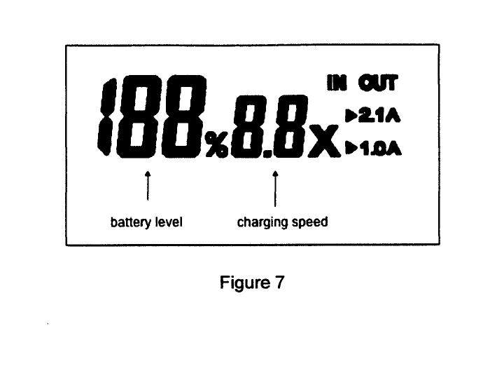

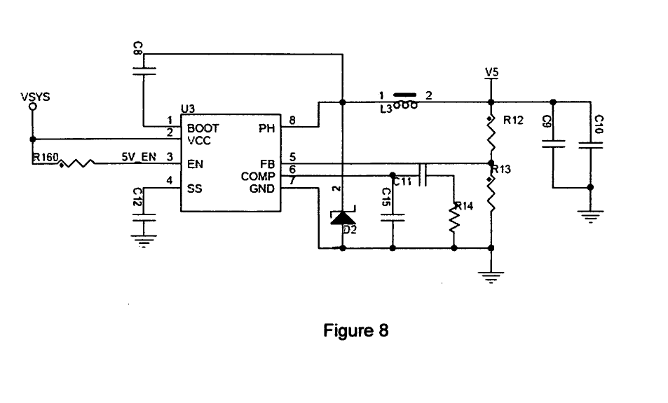

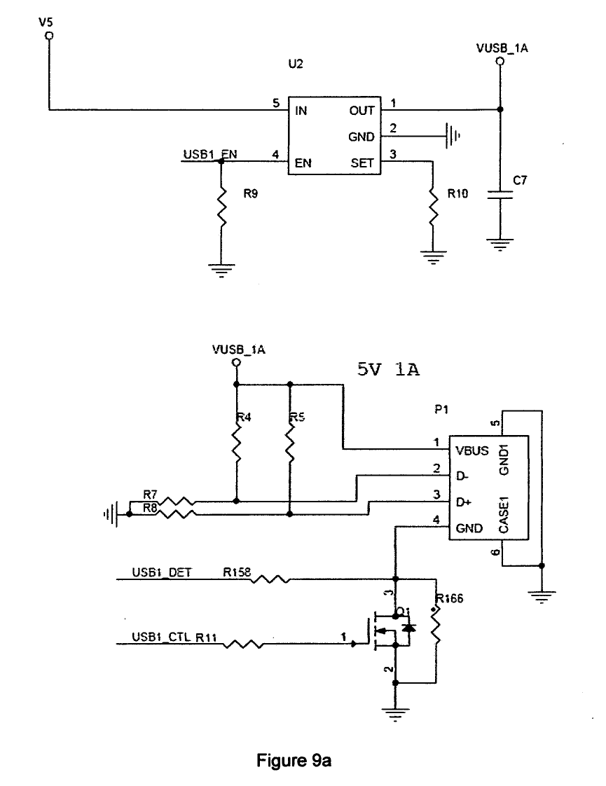

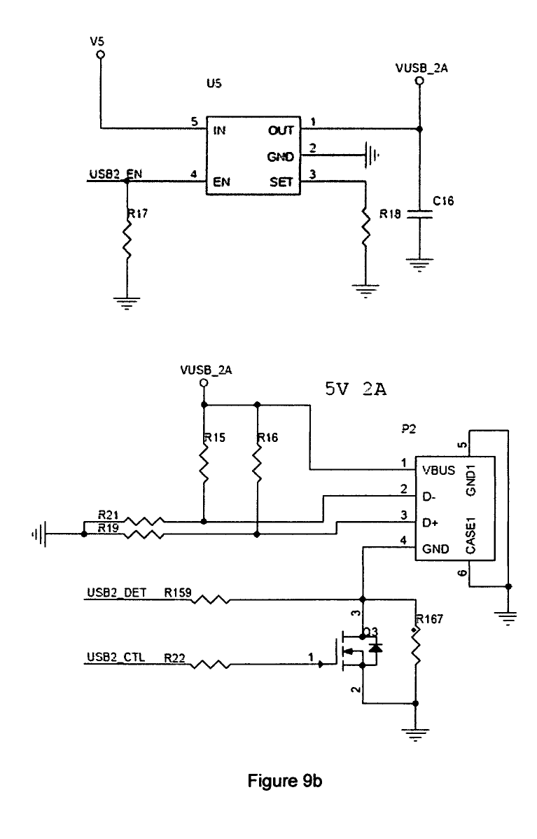

Turning now descriptively to the drawings of the embodiment of the utility model, in which similar reference characters denote similar elements throughout the several views, FIG. 1 through 9 illustrate a portable charging device (FIG. 1) that includes a charging module (FIG. 2), a battery protection module (FIG. 3), a built-in battery pack with multiple battery cells (FIG. 4), a voltage regulating output module (FIG. 8-9), a microcontroller module (FIG. 5), and an LCD display (FIG. 6-7). Said charging device 1 powers its externally connected electronic devices and in turn charges their batteries. Said charging module uses an input interface that matches the output interface of a personal computer's AC/DC power adapter. Said charging module charges said built-in battery pack through said battery protection module. Said built-in battery pack is connected to said voltage regulating output module to power externally connected electronic devices. Said microcontroller module connects to said battery protection module and said voltage regulating output module to control the charging and discharging process of said portable charging device. In view of the disadvantages inherent in known types of rechargeable battery packs present in the prior art, said portable charging device provides convenience to its user by reusing the user's existing computer AC/DC power adapter as the energy input. It packs multiple battery cells and connects them electronically in series to maximize the energy intake from the computer AC/DC power adapter, improve charging efficiency, and significantly shorten the charging time of said device.

FIG. 1 is the overall module diagram of an embodiment of the utility model, including a charging module 1, a battery protection module 2, a built-in battery pack with multiple battery cells 3, a voltage regulating output module 4, a microcontroller module 5, and an LCD display 7. Said charging module 1 uses an input interface that matches the output interface of a personal computer's AC/DC power adapter 6. Said charging module 1 comprises the first voltage reduction circuit of said portable charging device to drop input voltage from the computer power adapter 6 to 16.8V for feeding said battery protection module 2. Said built-in battery pack 3 include multiple battery cells electrically connected in series. Said voltage regulating output module 4 includes the second voltage reduction circuit of said portable charging device to reduce voltage from said built-in battery pack 3 to 5V for charging externally connected electronic devices. Said voltage regulating output module 4 also includes interfaces 401 that match the externally connected electronic devices. Said microcontroller module 5 connects to said battery protection module 2 and said voltage regulating output module 4 to control the charging and discharging process of said portable charging device. Said LCD display 7 is connected to said microcontroller module 5, which reads signals such as current and voltage from battery protection module 2 and voltage regulating output module 4 for displaying the battery status and charging and discharging information. Said computer power adapter 6 is also connected to said voltage regulating output module 4 via said charging module 1, as simplified in FIG. 1 as an illustrative direct connection between 6 and 4. When the computer power adapter 6 and external electronic device(s) are both connected to said portable charging device, the computer power adapter 6 provides direct charging to the external electronic device(s) through said charging module 1 and voltage regulating output module 4.

FIG. 2 is the voltage reduction circuit diagram of the embodiment's charging module 1. As seen in FIG. 2, said voltage reduction circuit adopts PWM voltage reduction and includes a DC-DC voltage reduction chip U1. Said computer power adapter 6 has an output voltage V20 that is about 20V. The output P+ of said voltage reduction circuit has a voltage of 16.8V, which is fed to said battery protection module 2 for charging said built-in battery pack 3.

FIG. 3 is the circuit diagram of the embodiment's battery protection module 2. As seen in FIG. 3, said battery protection module 2 receives voltage input P+ from said charging module 1, and charge serially connected multiple battery cells in said built-in battery back 3 between B+ and B−. Said battery protection module 2 includes protective and charge balancing circuits to prevent every battery cell in said built-in battery pack from overcurrent, overvoltage, overload, overcharge, over-discharge, short circuit, or overheating. For example, if any battery cell of said built-in battery pack 3 reaches a higher voltage than other cells, the control chip in said charge balancing circuit will turn on internal control switch to connect said battery cell to the ground and discharge the cell such that it reaches the same voltage as the other battery cells.

Said built-in battery pack 3 of the embodiment, as seen in FIG. 4, consists of 4 serially connected battery cells.

FIG. 5 is a schematic diagram of the embodiment's microcontroller module 5. As seen in FIG. 5, said microcontroller module 5 connects to said battery protection module 2 via its PD2/TIM2_CH3 pin (pin 27 in FIG. 5), reads signals such as current and voltage from said battery production module 2 via SM bus (system management bus controller), connects to said voltage regulating output module 4 via VDD pin (pin 6 in FIG. 5), reads signals such as voltage and current from said voltage regulating output module 4 via SM bus. VSYS in FIG. 5 is the voltage output terminal of said voltage regulating output module 4. Said microcontroller module 5 also connects to said LCD display 7, reads information via SM bus and displays it on said LCD display 7 to show the battery, charging, and discharging status of said portable charging device. FIG. 6 is a schematic diagram of the embodiment's LCD display 7 connections to the microcontroller module 5. Said microcontroller module 5 computes real-time charging power by reading and multiplying real-time current and voltage from battery protection module 2, and further divides the real-time charging power by 3.7 Watts to derive the charging speed multiplier for displaying on said LCD display 7. Said charging speed multiplier ranges from 0 to 9.9. 9.9 is displayed when actual value exceeds 9.9. FIG. 7 is an illustration of the display status of the embodiment's LCD display.

FIG. 8 is the voltage reduction circuit diagram of the embodiment's voltage regulating output module 4. As seen in FIG. 8, said voltage reduction circuit adopts PWM voltage reduction and includes a DC-DC voltage reduction chip U3. Said voltage reduction circuit reduces the output voltage VSYS from said built-in battery pack with serially connected battery cells 3 to 5V on V5 output terminal to charge externally connected electronic devices.

In this embodiment, said voltage regulating output module 4 also includes circuits to detect the connection of external devices and provide overcurrent protection during the process of charging those external devices. FIGS. 9a and 9b are diagrams of the overcurrent protection and external device detection circuits of the embodiment's voltage regulating output module 4, wherein FIG. 9a is the circuit diagram for IA output current and FIG. 9b is the circuit diagram for 2A output current. In the absence of an externally connected electronic device, pin 4 of P1/P2 is pulled to ground and set to the low-voltage state, and Q1/Q3 MOS components are put to shutoff state. When an external device is connected, voltage on pin 4 of P1/P2 rises, which is detected by the I/O pins of microcontroller and triggers an interrupt signal. Microcontroller processes the interrupt upon detecting it, opens Q1/Q3, pulls pin 4 of P1/P2 to ground, and starts charging the external devices. P1/P2's 5V power source comes from limit-current switch IC U2/U5. Said limit-current switches can provide 1A and 2A current respectively. When an external device draws a current beyond limits or there is a short circuit, IC will shut off automatically and in turn stops the external charging process. IC will return to its normal working state once fault clears.

Known types of rechargeable battery packs present in the prior art connect internal battery cells electrically in parallel, and typically use 5V input and reduce the voltage to 4.2V to charge the battery cells. In light of power loss and the fact that most common 5V power sources typically supply 1A current or less, battery cells of said battery packs in the prior art only receive about 4 W charging power input. In this new utility model, internal battery cells are electrically connected in series and require much higher charging voltage. For example, four serially connected battery cells requires 16.8V. Laptop computer AC/DC power adapters have sufficient voltage to charge said new portable charging device, with power typically ranging from 40 W to 90 W and voltage around 20V. This new utility model uses interface that is compatible with laptop computer power adapter output and adjust the voltage to the level matching the internal battery cells. By making use of high power output from the computer power adapter, said new portable charging device achieves both shorter charging time and the convenience of eliminating the user's need to carry another power adapter or cable. In summary, the new portable charging device provides better convenience by using commonplace personal computer AC/DC power adapter as the input and achieves faster recharging at comparable size, weight, and capacity by serially connecting multiple battery cells to take advantage of the computer power adapter's high power output. At 10,000 mAh capacity, for example, the new portable charging device can shorten the required full recharge time by more than 2 hours.

It should be noted that, herein, relational terms such as “first”, “second” and alike are only used to distinguish one entity or operation from another entity or operation, without requiring or implying any order or relationship among the entities or operations. Furthermore, the terms “comprises”, “comprising”, “includes”, “including” or any other variation thereof, are intended to convey a non-exclusive inclusion such that the process, method, object or device that covers a series of elements not only includes the listed series of elements but also covers elements not expressly listed and inherent elements of such process, method, object or device. In the absence of additional qualifiers, the statement such as “includes one . . . ” does not exclude the existence of additional elements in the process, including the element, method, object, or device.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A portable charging device that include a charging module, a battery protection module, a built-in battery pack with multiple battery cells, a voltage regulating output module, a microcontroller module, and an LCD display, wherein said charging module uses an input interface that matches the output interface of a personal computer's AC/DC power adapter, said charging module charges said built-in battery pack through said battery protection module, said built-in battery pack is connected to said voltage regulating output module to power externally connected electronic devices, said microcontroller module connects to said battery protection module and said voltage regulating output module to control the charging and discharging process of said portable charging device, and said built-in battery pack includes multiple battery cells electrically connected in series.

2. The portable charging device of claim 1, wherein said multiple battery pack includes 4 battery cells electrically connected in series.

3. The portable charging device of claim 2, wherein said charging module comprises the first voltage reduction circuit of said portable charging device to drop input voltage from the computer AC/DC power adapter to 16.8V for feeding said battery protection module.

4. The portable charging device of claim 1, wherein said charging module is also connected to said voltage regulating output module, When the computer power adapter and external electronic device(s) are both connected to said portable charging device, the computer power adapter provides direct charging to the external electronic device(s) through said charging module and voltage regulating output module.

5. The portable charging device of claim 1, wherein said battery protection module includes protective and charge balancing circuits to prevent every battery cell in said portable charging device from overcurrent, overvoltage, overload, overcharge, over-discharge, short circuit, or overheating.

6. The portable charging device of claim 1, wherein said voltage regulating output module includes the second voltage reduction circuit of said portable charging device to drop voltage from said built-in battery pack with serially connected battery cells to 5V for charging externally connected electronic devices.

7. The portable charging device of claim 6, wherein said voltage regulating output module also includes circuits to detect the connection of external devices and provide overcurrent protection during the process of charging those external devices.

8. The portable charging device of claim 6, wherein said voltage regulating output module also includes interfaces that match the externally connected electronic devices.

9. Any portable charging device of claim 1-7, wherein said LCD display is connected to said microcontroller module for displaying the battery status and charging and discharging information.
